(19) United States
(12) Patent Application Publication
(10) Pub. No.: US 2019/0244195 A1
(43) Pub. Date: Aug. 8, 2019

(54) BLOCKCHAIN SYSTEM SUPPORTING PUBLIC AND PRIVATE TRANSACTIONS UNDER ACCOUNT MODELS

(71) Applicant: Alibaba Group Holding Limited, George Town (KY)

(72) Inventors: Baoli Ma, Hangzhou (CN); Wenbin Zhang, Hangzhou (CN)

(73) Assignee: Alibaba Group Holding Limited, George Town (KY)

(21) Appl. No.: 16/390,199

(22) Filed: Apr. 22, 2019

Related U.S. Application Data
(63) Continuation of application No. PCT/CN2018/114401, filed on Nov. 7, 2018.

(51) Int. Cl. G06Q 20/38; H04L 9/06; H04L 9/32; H04L 9/00

(52) U.S. Cl. CPC G06Q 20/3825; H04L 9/008; H04L 9/3247; H04L 9/0637

(57) ABSTRACT

Implementations of the present disclosure include receiving, by a consensus node of a blockchain, transaction data and a digital signature of the transaction data. The transaction data includes a commitment value, a random number, and a transaction amount to be transferred from one of a public account or a private account of the first user node to one of a public account or a private account of a second user node. The consensus node verifies the digital signature of the transaction data using a public key of the first user node. It then determines that the transaction amount is valid, if the commitment value is correct based on the random number and the commitment scheme, and the transaction amount is less than or equal to a balance of the one of the public account or the private account of the first user node before transfer of the transaction amount.

### CROSS-REFERENCE TO RELATED APPLICATIONS

This application is a continuation of PCT Application No. PCT/CN2018/114401, filed on Nov. 7, 2018, which is hereby incorporated by reference in its entirety.

### BACKGROUND

Blockchain networks, which can also be referred to as blockchain systems, consensus networks, distributed ledger system (DLS) networks, or blockchain, enable participating entities to securely, and immutably store data. A blockchain can be described as a ledger of transactions, and multiple copies of the blockchain are stored across the blockchain network. Example types of blockchains can include public blockchains, and private blockchains. A public blockchain is open for all entities to use the blockchain, and participate in the consensus process. A private blockchain is provided for a particular entity, which centrally controls read, and write permissions.

Blockchains are used in crypto-currency networks, which enable participants to conduct transactions to buy/sell goods, and/or services using a crypto-currency. A common crypto-currency includes Bitcoin. In crypto-currency networks, record-keeping models are used to record transactions between users. Example record-keeping models include the unspent transaction output (UTXO) model, and the account balance model. In the UTXO model, each transaction spends output from prior transactions and generates new outputs that can be spent in subsequent transactions. A user's unspent transactions are tracked, and a balance that the user has to spend is calculated as the sum of the unspent transactions. In the account balance model, each user's account balance is tracked as a global state. For each transaction, a balance of a spending account is checked to make sure it is larger than, or equal to, the transaction amount. This is comparable to traditional banking.

A blockchain includes a series of blocks, each of which contains one or more transactions executed in the network. Each block can be analogized to a page of the ledger, while the blockchain itself is a full copy of the ledger. Individual transactions are confirmed and added to a block, which is added to the blockchain. Copies of the blockchain are replicated across nodes of the network. In this manner, there is global consensus on the state of the blockchain. Further, the blockchain is open for all nodes to see, at least in the case of public networks. To protect privacy of blockchain users, encryption technologies are implemented.

### SUMMARY

Implementations of the present disclosure include computer-implemented methods for protecting privacy of public and private transaction data under the account balance model of a blockchain network. More particularly, implementations of the present disclosure are directed to enabling private transactions and public transactions under the account balance model within a blockchain network. In this manner, and as described in further detail herein, users can freely choose whether each transaction is a public transaction, or a private transaction within the blockchain network.

In some implementations, actions include receiving, by a consensus node of a blockchain network, transaction data and a digital signature of the transaction data, wherein the transaction data includes a commitment value, a random number, and a transaction amount to be transferred from one of a public account or a private account of the first user node to one of a public account or a private account of a second user node, and wherein the digital signature is generated by digitally signing the transaction data using a private key of the first user node and the commitment value is generated based on the random number and the transaction amount using a commitment scheme; verifying the digital signature of the transaction data using a public key of the first user node; and

determining that the transaction amount is valid, if the commitment value is correct based on the random number and the commitment scheme, and the transaction amount is less than or equal to a balance of the one of the public account or the private account of the first user node before transfer of the transaction amount. Other implementations include corresponding systems, apparatus, and computer programs, configured to perform the actions of the methods, encoded on computer storage devices.

These and other implementations may each optionally include one or more of the following features:

A first feature, combinable with any of the following features, wherein the public account has a public balance viewable by the consensus node, and the private account has a private balance viewable using a private key of a respective user node.

A second feature, combinable with any of the previous or following features, wherein the transaction amount is from a public account associated with the first user node to a private account associated with the second user node.

A third feature, combinable with any of the previous or following features, wherein the transaction amount is from the private account of the first user node to the public account of the second user node, and the method further comprises: receiving, from the first user node, a range proof to prove that the transaction amount is less than or equal to a balance of the private account of the first user node; and wherein the transfer is determined valid, if the transaction amount is less than or equal to the balance of the private account of the first user node based on the range proof.

A fourth feature, combinable with any of the previous or following features, further comprising updating the balance of the one of the public account or the private account of the first user node, and the balance of the one of the public account or the private account of the second user node based on the transaction amount, if the transfer is valid.

A fifth feature, combinable with any of the previous or following features, wherein the balance of the private account is updated based on the commitment value of the transaction amount and a commitment of the balance of the private account generated using the commitment scheme.

A sixth feature, combinable with any of the previous or following features, wherein the commitment scheme is homomorphic.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example environment that can be used to execute implementations of the present disclosure.

FIG. 2 depicts an example conceptual architecture in accordance with implementations of the present disclosure.

FIG. 3 depicts an example validation process of a blockchain transaction in accordance with implementations of the present disclosure.

FIG. 4 depicts an example blockchain transaction from a public account to a private account in accordance with implementations of the present disclosure.

FIG. 5 depicts an example blockchain transaction from a private account to a public account in accordance with implementations of the present disclosure.

FIG. 6 depicts an example method that can be executed in accordance with implementations of the present disclosure.

Like reference symbols in the various drawings indicate like elements.

### DETAILED DESCRIPTION

Implementations of the present disclosure include computer-implemented methods for protecting privacy of public and private transaction data under the account balance model (also referred to herein as the account model) of a blockchain network. More particularly, implementations of the present disclosure are directed to enabling private transactions and public transactions under the account balance model within a blockchain network. In this manner, and as described in further detail herein, users can freely choose whether each transaction is a public transaction, or a private transaction within the blockchain network. In some implementations, actions include receiving, by a consensus node of a blockchain network, transaction data and a digital signature of the transaction data, wherein the transaction data includes a commitment value, a random number, and a transaction amount to be transferred from one of a public account or a private account of the first user node to one of a public account or a private account of a second user node, and wherein the digital signature is generated by digitally signing the transaction data using a private key of the first user node and the commitment value is generated based on the random number and the transaction amount using a commitment scheme; verifying the digital signature of the transaction data using a public key of the first user node; and determining that the transaction amount is valid, if the commitment value is correct based on the random number and the commitment scheme, and the transaction amount is less than or equal to a balance of the one of the public account or the private account of the first user node before transfer of the transaction amount.

To provide further context for implementations of the present disclosure, and as introduced above, blockchain networks, which can also be referred to as consensus networks (e.g., made up of peer-to-peer nodes), distributed ledger system, or simply blockchain, enable participating entities to securely, and immutably conduct transactions, and store data. A blockchain can be provided as a public blockchain, a private blockchain, or a consortium blockchain. Implementations of the present disclosure are described in further detail herein with reference to a public blockchain, which is public among the participating entities. It is contemplated, however, that implementations of the present disclosure can be realized in any appropriate type of blockchain.

In a public blockchain, the consensus process is controlled by nodes of the consensus network. For example, hundreds, thousands, even millions of entities can participate in a public blockchain, each of which operates at least one node in the public blockchain. Accordingly, the public blockchain can be considered a public network with respect to the participating entities. In some examples, a majority of entities (nodes) must sign every block in order for the block to be valid and added to the blockchain. An example public blockchain includes the blockchain used in the Bitcoin network, which is a peer-to-peer payment network (crypto-currency network). Although the term blockchain is commonly references in hand with the Bitcoin network, as used herein, blockchain generally refers to distributed ledgers without particular reference to the Bitcoin network.

In general, a public blockchain supports public transactions. A public transaction is shared with all of the nodes within the blockchain, because the blockchain is replicated across all nodes. That is, all nodes are in perfect state consensus with respect to the blockchain. To achieve consensus (e.g., agreement to the addition of a block to a blockchain), a consensus protocol is implemented within the blockchain network. An example consensus protocol includes, without limitation, proof-of-work (POW) implemented in the Bitcoin network.

Implementations of the present disclosure are described in further detail herein in view of the above context. More particularly, and as introduced above, implementations of the present disclosure are directed to enabling private transactions and public transactions under the account balance model within a blockchain network. In this manner, and as described in further detail herein, users can freely choose whether each transaction is a public transaction, or a private transaction within the blockchain network.

In accordance with implementations of the present disclosure, account structures based on account models enable transactions between public accounts, transactions between private accounts, and transactions between public and private accounts. A proper privacy protection scheme can be implemented for different account types. In this manner, a user (e.g., node in the network) can select whether to perform transactions using public account or private account based on privacy preferences.

A public account can have an account balance viewable by the consensus nodes. A private account can have an account balance viewable using a private key of an owner (user) of the account. The private account balance can be encrypted using homomorphic encryption, or committed to by a commitment scheme with homomorphism. As such, the private account balance cannot be determined by other nodes in the blockchain network. The transaction amount made to or from a private account can also be hidden based on the commitment scheme to update the private account balance based on homomorphic encryption.

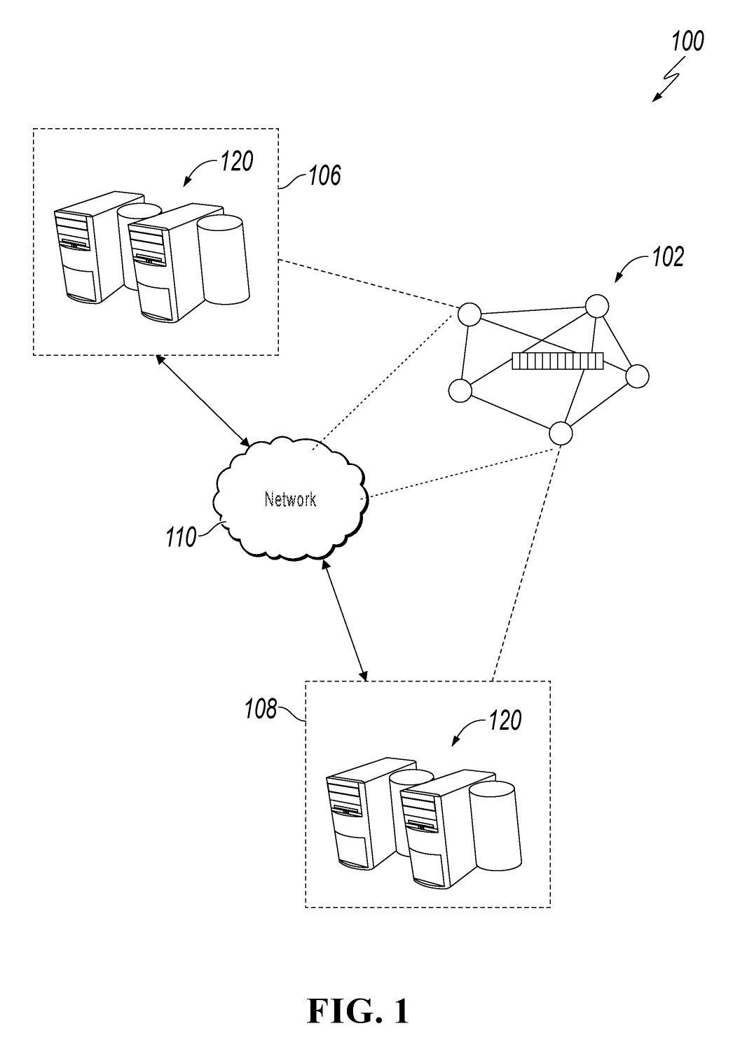

FIG. 1 depicts an example environment 100 that can be used to execute implementations of the present disclosure. In some examples, the example environment 100 enables entities to participate in a public blockchain 102. The example environment 100 includes computing systems 106, 108, and a network 110. In some examples, the network 110 includes a local area network (LAN), wide area network (WAN), the Internet, or a combination thereof, and connects web sites, user devices (e.g., computing devices), and back-end systems. In some examples, the network 110 can be accessed over a wired and/or a wireless communications link.

In the depicted example, the computing systems 106, 108 can each include any appropriate computing system that enables participation as a node in the public blockchain 102. Example computing devices include, without limitation, a server, a desktop computer, a laptop computer, a tablet computing device, and a smartphone. In some examples, the computing systems 106, 108 hosts one or more computer-implemented services for interacting with the public blockchain 102. For example, the computing system 106 can host computer-implemented services of a first entity (e.g., user A), such as a transaction management system that the first entity uses to manage its transactions with one or more other entities (e.g., other users). The computing system 108 can host computer-implemented services of a second entity (e.g., user B), such as transaction management system that the second entity uses to manage its transactions with one or more other entities (e.g., other users). In the example of FIG. 1, the public blockchain 102 is represented as a peer-to-peer network of nodes, and the computing systems 106, 108 provide nodes of the first entity, and second entity respectively, which participate in the public blockchain 102.

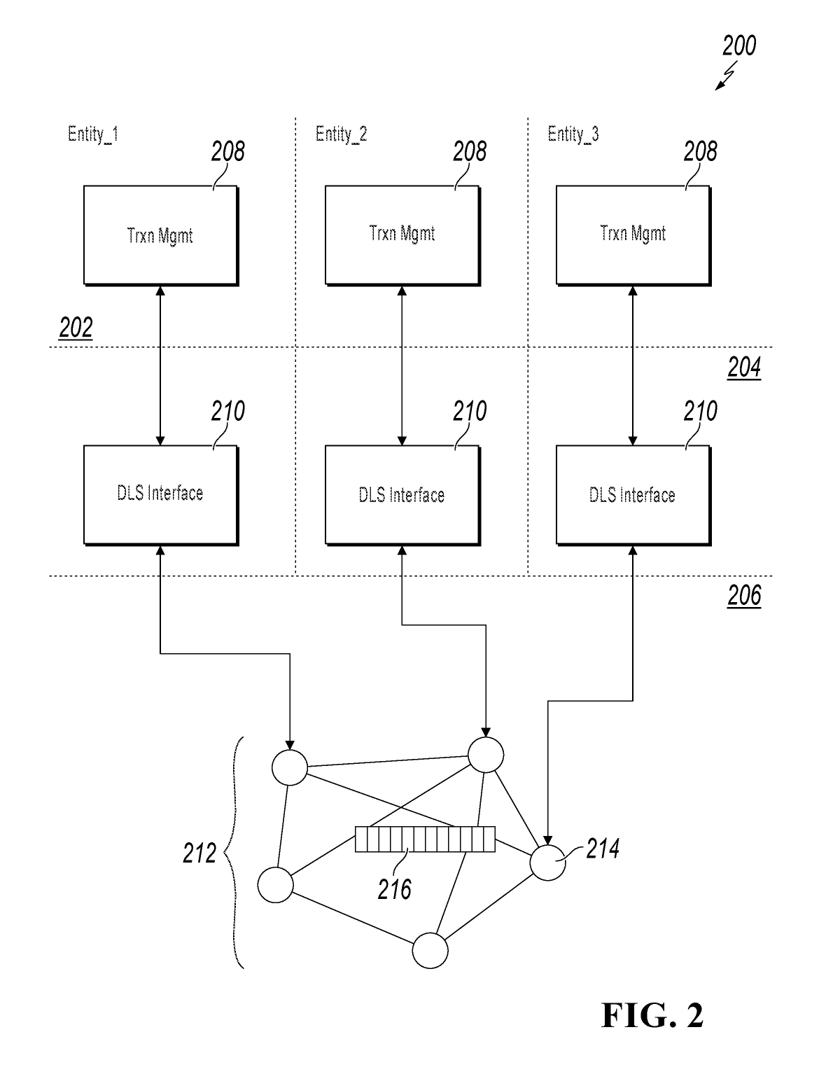

FIG. 2 depicts an example conceptual architecture 200 in accordance with implementations of the present disclosure. The example conceptual architecture 200 includes an entity layer 202, a hosted services layer 204, and a public blockchain layer 206. In the depicted example, the entity layer 202 includes three entities, Entity_1 (E1), Entity_2 (E2), and Entity_3 (E3), each entity having a respective transaction management system 208.

In the depicted example, the hosted services layer 204 includes blockchain or DLS interfaces 210 for each transaction management system 208. In some examples, a respective transaction management system 208 communicates with a respective DLS interface 210 over a network (e.g., the network 110 of FIG. 1) using a communication protocol (e.g., hypertext transfer protocol secure (HTTPS)). In some examples, each DLS interface 210 provides a communication connection between a respective transaction management system 208, and the blockchain layer 206. More particularly, each DLS interface 210 enables the respective entity to conduct transactions recorded in a blockchain network 212 of the blockchain layer 206. In some examples, communication between a DLS interface 210, and the blockchain layer 206 is conducted using remote procedure calls (RPCs). In some examples, the DLS interfaces 210 “host” blockchain nodes for the respective transaction management systems 208. For example, the DLS interfaces 210 provide the application programming interface (API) for access to the blockchain network 212.

As described herein, the blockchain network 212 is provided as a peer-to-peer network including a plurality of nodes 214 that immutably record information in a blockchain 216. Although a single blockchain 216 is schematically depicted, multiple copies of the blockchain 216 are provided, and are maintained across the blockchain 212. For example, each node 214 stores a copy of the blockchain 216. In some implementations, the blockchain 216 stores information associated with transactions that are performed between two or more entities participating in the public blockchain.

The present disclosure discloses methods that can enable private transactions and public transactions to be performed under the account balance model within a blockchain network based on commitment schemes. In this manner, users can freely choose whether each transaction or the account used for the transaction is public or a private.

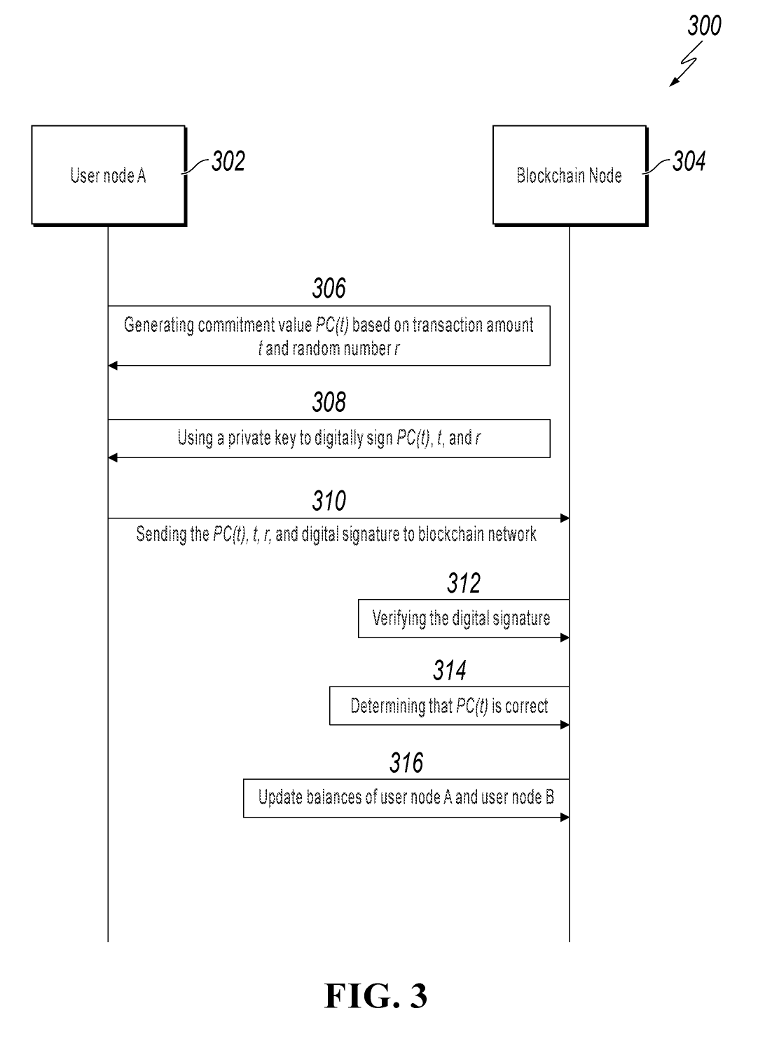

FIG. 3 depicts a swim-lane diagram illustrating an example validation process 300 of a blockchain transaction in accordance with implementations of the present disclosure. For the purpose illustrating the example validation process 300, a fund transfer transaction is assumed to be performed by a user node A 302 to a user node B (not shown in FIG. 3), and the transaction is submitted by the user node A 302 to a blockchain node 304 for validation. Each of the user node A 302, and the user node B can include a public account and a private account. A balance of the public account can be viewable by all nodes in the blockchain network. A balance of the private account can be viewable only by the account owner (user) using a private key. In accordance with implementations of the present disclosure, the user nodes can select whether to perform transactions publicly or privately using a public account or a private account.

At 306, the user node A 302 generates a commitment value based on a transaction amount t, and a random number r. The commitment value can be generated by a homomorphic commitment scheme. An example commitment scheme includes, without limitation, the Pedersen Commitment (PC). Although implementations of the present disclosure are described in further detail herein with reference to the PC, it is contemplated that implementations of the present disclosure can be realized using any appropriate commitment scheme.

Using the PC, for example, the commitment value is a cypher text that can be denoted as PC(t)=rG+tH, where G and H can be generators of an elliptical curve, PC(t) is a scalar multiplication of curve points, t is the value that is committed to. The PC commitment scheme has a homomorphism, that is, PC(t₁)+PC(t₂)=PC(t₁+t₂). Holders of the cypher text PC(t) can verify the transaction amount t by using the random number r. At 308, the user node A 302 uses a private key to digitally sign the commitment value PC(t), the transaction amount t, and the random number r. The user node A 302 submits the commitment value PC(t), the transaction amount t, the random number r, and the digital signature to the blockchain node 304 at 310.

In some implementations, the transaction amount t can be sent from a private account of the user node A 302. For a private account, whether the account has enough balance to transfer the transaction amount t cannot be directly verified by other nodes of the blockchain. In such cases, the user node A 302 can generate one or more range proofs to show that the transaction amount t is greater than or equal to zero, and less than or equal to a balance of the private account of the user node A 302.

At 312, the blockchain node 304 verifies the digital signature of the commitment value PC(r, t), the transaction amount t, and the random number r using a public key of the user node A 302. If the digital signature is correct, the example validation process 300 proceeds to 314.

At 314, the blockchain node 304 verifies whether the commitment value PC(t) is correct and the transaction amount t is valid. To verify if PC(t) is correct, the received random number r and the transaction amount t can be used to generate the PC denoted as PC′(r, t). If PC′(r, t) equals the received commitment PC(r, t), the commitment PC(r, t) is verified to be the correct commitment of the transaction amount t. In some implementations, the blockchain node 304 can verify that the transaction amount t is valid if it is great than or equal to 0, and less than or equal to the account balance of the user node A's 302 account where the transaction amount is transferred from based on the one or more range proofs.

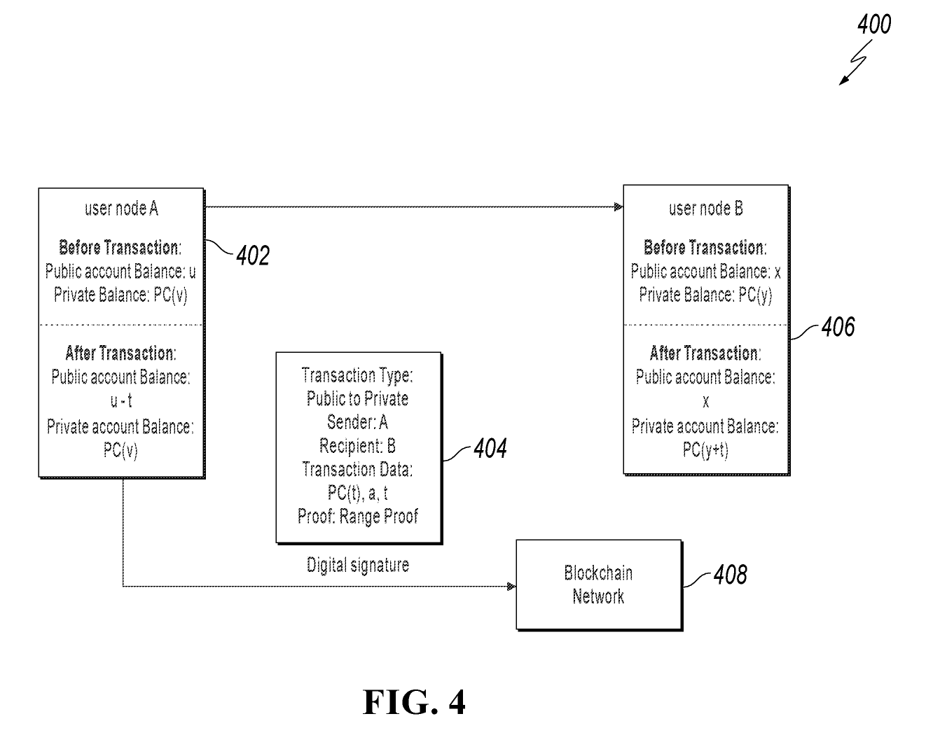

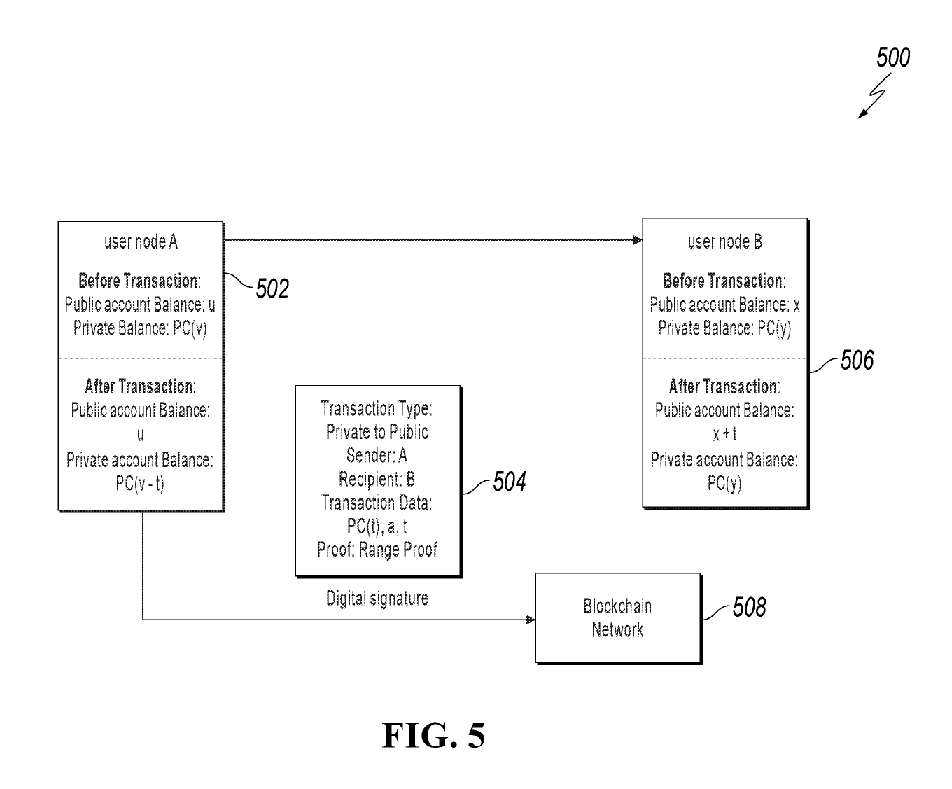

At 316, the blockchain node 304 updates balances of the user node A 302, and the user node B on the blockchain, and broadcasts the blockchain to the rest of nodes in the blockchain network. For public account transactions, the transaction amount can be directly subtracted from, or added to the balance of the public account based on the transaction type. For private account transactions, the transaction amount t can be committed to using PC as PC(t), and subtracted from, or added to a private account balance s also committed to using PC as PC(s). Because PC is homomorphic, PC(s)±PC(t)=PC(s±t). Details of updating public and private account balances are described in further detail herein with references to FIGS. 4 and 5.

FIG. 4 depicts a block diagram illustrating an example transaction 400 from a public account to a private account in accordance with implementations of the present disclosure. As shown in the example transaction 400, before the transaction, a user node A 402 has a public account balance u, and a private account balance v committed to using PC and expressed as PC(v). A user node B 406 has a public account balance x, and a private account balance y committed to using PC and expressed as PC(y). The user node A 402 can submit a transaction from its public account to the private account of user node B 406 by sending a digitally signed copy of a commitment value PC(t), the transaction amount t, and a random number a corresponding to the commitment value to a blockchain network 408. After the commitment value PC(t) of the transaction amount t is verified using a validation process, such as the example process 300 of FIG. 3, the accounts of the user node A 402, and the user node B 406 can be updated. After the transaction is validated by the blockchain network 408, a transaction amount t is subtracted from the public account of the user node A 402, and is added to the private account of the user node B 406. After the transaction, the user node A 400 has a public account balance u−t, and a private account balance PC(v). The user node B 406 has a public account balance x, and a private account balance PC(y+t).

FIG. 5 depicts a block diagram illustrating an example transaction 500 from a private account to a public account in accordance with implementations of the present disclosure. As shown in the example transaction 500, before the transaction, a user node A 502 has a public account balance u and a private account balance v committed to using PC and expressed as PC(v). A user node B 506 has a public account balance x, and a private account balance y committed to using PC and expressed as PC(y). The user node A 502 can submit a transaction from its private account to a public account of the user node B 506 public account, by sending a digitally signed copy of a commitment value PC(t), the transaction amount t, a random number a corresponding to the commitment value, and one or more range proofs. The one or more range proofs can be used to prove that 0≤t≤v to a blockchain network 508. After the commitment value PC(t) of the transaction amount t is verified using a validation process, such as the example process 300 of FIG. 3, the accounts of the user node A 502, and the user node B 506 can be updated. After the transaction is validated by the blockchain network 508, a transaction amount t is subtracted from the private account of the user node A, and is added to the public account of the user node B 506 public account. After the transaction, the user node A 502 has a public account balance u, and a private account balance PC(v−t). The user node B 504 has a public account balance x+t, and a private account balance PC(y).

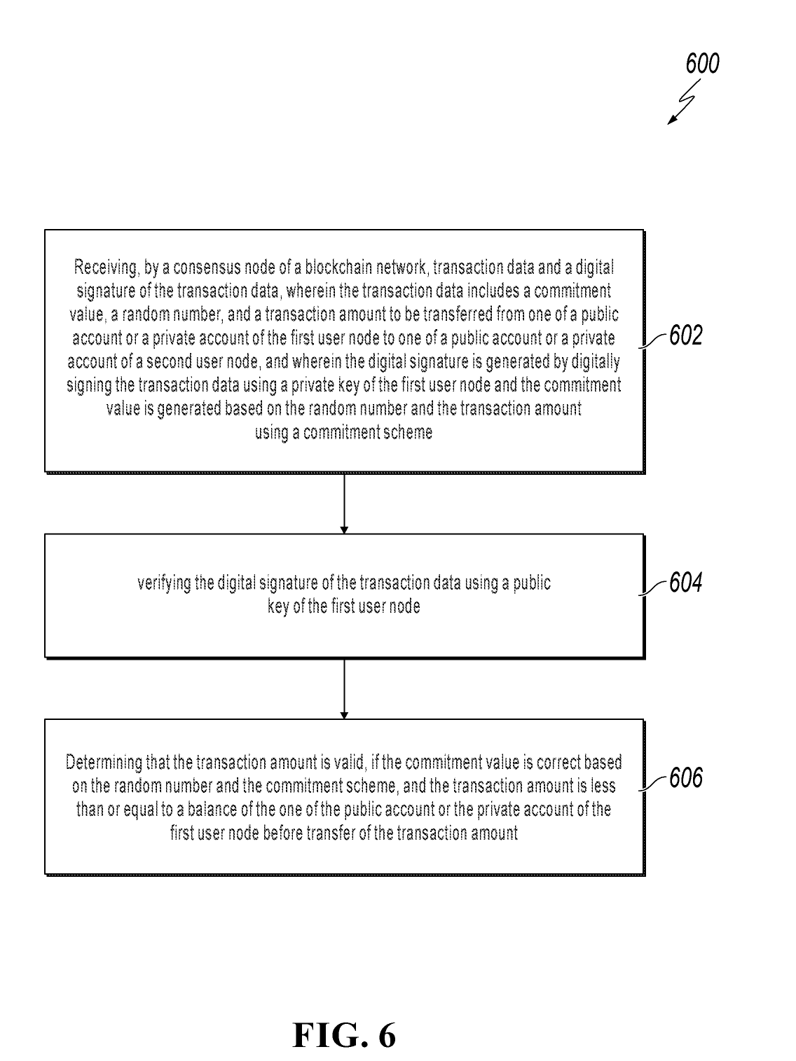

FIG. 6 depicts an example method 600 that can be executed in accordance with implementations of the present disclosure. For clarity of presentation, the description that follows generally describes the example method 600 in the context of the other figures in this description. However, it will be understood that the example method 600 can be performed, for example, by any system, environment, software, and hardware, or a combination of systems, environments, software, and hardware, as appropriate. In some implementations, various steps of the example method 600 can be run in parallel, in combination, in loops, or in any order.

At 602, a consensus node of a blockchain network receives transaction data and a digital signature of the transaction data. In some implementations, the transaction data includes a commitment value, a random number, and a transaction amount to be transferred from one of a public account or a private account of the first user node to one of a public account or a private account of a second user node. The digital signature is generated by digitally signing the transaction data using a private key of the first user node. The commitment value is generated based on the random number and the transaction amount using a commitment scheme. In some implementations, the commitment scheme is homomorphic. In some implementations, the transaction amount is from a public account associated with the first user node to a private account associated with the second user node. In some implementations, the transaction amount is from a private account associated with the first user node to a public account of the second user node. In such cases, the consensus node can also receive, from the first user node, a range proof to prove that the transaction amount is less than or equal to a balance of the private account of the first user node.

At 604, the consensus node verifies the digital signature of the transaction data using a public key of the first user node.

At 606, the consensus node determines that the transaction amount is valid, if the commitment value is correct based on the random number and the commitment scheme. The consensus node also determines that the transaction amount is less than or equal to a balance of the one of the public account or the private account of the first user node before transfer of the transaction amount. In some implementations, the transaction amount is from a private account of the first user node to a public account of the second user node. In such cases, determining that the balance transfer is valid also includes determining whether the transaction amount is less than or equal to the balance of the private account associated with the first user node based on the range proof.

In some implementations, the example method 600 can also include updating the balance of the one of the public account or the private account associated with the first user node and the balance of the one of the public account or the private account associated with the second user node. The update can be performed based on the transaction amount, if the transaction amount is valid. In some implementations, the balance of the private account is updated based on the commitment value of the transaction amount and a commitment of the balance of the private account generated using the commitment scheme.

Implementations of the subject matter described in this specification can be implemented so as to realize particular advantages or technical effects. For example, implementations of the present disclosure permit a blockchain network to support transactions between public accounts, transactions between private accounts, and transactions between public, and private accounts. As such, the proper privacy protection can be implemented regardless of account types, so a user node of the blockchain network can flexibly choose to send and receive funds from its public account or private account based on privacy preferences.

The described methodology permits enhancement of account/data security of various mobile computing device. The balance of the private account can be committed to based on a commitment scheme. As such, the balance of the private account can be verified based on commitment without revealing the actual account balance of the account. The transaction amount made to or from a private account can also be committed to based on the commitment scheme to update the private account after transaction without revealing the actual amount transferred. In this manner, more control over the security of private account transactions is provided.

The described methodology can ensure the efficient usage of computer resources (for example, processing cycles, network bandwidth, and memory usage), through the efficient update of the blockchain. The account operations can be more quickly and securely made through simpler consensus processes.

Implementations and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the present disclosure can be realized using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method for validating blockchain transactions based on account models, comprising:
receiving, by a consensus node of a blockchain network, transaction data and a digital signature of the transaction data, wherein the transaction data includes a commitment value, a random number, and a transaction amount to be transferred from one of a public account or a private account of a first user node to one of a public account or a private account of a second user node, and wherein the digital signature is generated by digitally signing the transaction data using a private key of the first user node and the commitment value is generated based on the random number and the transaction amount using a commitment scheme;
verifying the digital signature of the transaction data using a public key of the first user node; and
determining that the transaction amount is valid, if the commitment value is correct based on the random number and the commitment scheme, and the transaction amount is less than or equal to a balance of the one of the public account or the private account of the first user node before transfer of the transaction amount.

2. The computer-implemented method of claim 1, wherein the public account has a public balance viewable by the consensus node, and the private account has a private balance viewable using a private key of a respective user node.

3. The computer-implemented method of claim 1, wherein the transaction amount is from a public account associated with the first user node to a private account associated with the second user node.

4. The computer-implemented method of claim 1, wherein the transaction amount is from the private account of the first user node to the public account of the second user node, and the method further comprises:
receiving, from the first user node, a range proof to prove that the transaction amount is less than or equal to a balance of the private account of the first user node; and
wherein the transfer is determined valid, if the transaction amount is less than or equal to the balance of the private account of the first user node based on the range proof.

5. The computer-implemented method of claim 2, further comprising updating the balance of the one of the public account or the private account of the first user node, and the balance of the one of the public account or the private account of the second user node based on the transaction amount, if the transfer is valid.

6. The computer-implemented method of claim 5, wherein the balance of the private account is updated based on the commitment value of the transaction amount and a commitment of the balance of the private account generated using the commitment scheme.

7. The computer-implemented method of claim 1, wherein the commitment scheme is homomorphic.

8. A non-transitory, computer-readable medium storing one or more instructions executable by a computer system to perform operations comprising:
receiving, by a consensus node of a blockchain network, transaction data and a digital signature of the transaction data, wherein the transaction data includes a commitment value, a random number, and a transaction amount to be transferred from one of a public account or a private account of a first user node to one of a public account or a private account of a second user node, and wherein the digital signature is generated by digitally signing the transaction data using a private key of the first user node and the commitment value is generated based on the random number and the transaction amount using a commitment scheme;
verifying the digital signature of the transaction data using a public key of the first user node; and
determining that the transaction amount is valid, if the commitment value is correct based on the random number and the commitment scheme, and the transaction amount is less than or equal to a balance of the one of the public account or the private account of the first user node before transfer of the transaction amount.

9. The non-transitory, computer-readable medium of claim 8, wherein the public account has a public balance viewable by the consensus node, and the private account has a private balance viewable using a private key of a respective user node.

10. The non-transitory, computer-readable medium of claim 8, wherein the transaction amount is from a public account associated with the first user node to a private account associated with the second user node.

11. The non-transitory, computer-readable medium of claim 8, wherein the transaction amount is from the private account of the first user node to the public account of the second user node, and the operations further comprise:
receiving, from the first user node, a range proof to prove that the transaction amount is less than or equal to a balance of the private account of the first user node; and
wherein the transfer is determined valid, if the transaction amount is less than or equal to the balance of the private account of the first user node based on the range proof.

12. The non-transitory, computer-readable medium of claim 9, the operations further comprising updating the balance of the one of the public account or the private account of the first user node, and the balance of the one of the public account or the private account of the second user node based on the transaction amount, if the transfer is valid.

13. The non-transitory, computer-readable medium of claim 12, wherein the balance of the private account is updated based on the commitment value of the transaction amount and a commitment of the balance of the private account generated using the commitment scheme.

14. The non-transitory, computer-readable medium of claim 8, wherein the commitment scheme is homomorphic.

15. A system, comprising:
one or more computers; and
one or more computer-readable memories coupled to the one or more computers and having instructions stored thereon which are executable by the one or more computers to perform operations comprising:
receiving, by a consensus node of a blockchain network, transaction data and a digital signature of the transaction data, wherein the transaction data includes a commitment value, a random number, and a transaction amount to be transferred from one of a public account or a private account of a first user node to one of a public account or a private account of a second user node, and wherein the digital signature is generated by digitally signing the transaction data using a private key of the first user node and the commitment value is generated based on the random number and the transaction amount using a commitment scheme;
verifying the digital signature of the transaction data using a public key of the first user node; and
determining that the transaction amount is valid, if the commitment value is correct based on the random number and the commitment scheme, and the transaction amount is less than or equal to a balance of the one of the public account or the private account of the first user node before transfer of the transaction amount.

16. The system of claim 15, wherein the public account has a public balance viewable by the consensus node, and the private account has a private balance viewable using a private key of a respective user node.

17. The system of claim 15, wherein the transaction amount is from a public account associated with the first user node to a private account associated with the second user node.

18. The system of claim 15, wherein the transaction amount is from the private account of the first user node to the public account of the second user node, and the operations further comprise:
receiving, from the first user node, a range proof to prove that the transaction amount is less than or equal to a balance of the private account of the first user node; and
wherein the transfer is determined valid, if the transaction amount is less than or equal to the balance of the private account of the first user node based on the range proof.

19. The system of claim 16, the operations further comprising updating the balance of the one of the public account or the private account of the first user node, and the balance of the one of the public account or the private account of the second user node based on the transaction amount, if the transfer is valid.

20. The system of claim 19, wherein the balance of the private account is updated based on the commitment value of the transaction amount and a commitment of the balance of the private account generated using the commitment scheme.
